(19) United States
(12) Patent Application Publication
(10) Pub. No.: US 2022/0374773 A1
(43) Pub. Date: Nov. 24, 2022

(54) SYSTEM AND METHOD FOR USING MACHINE LEARNING MODELS WITH SENSORS TO INTERPRET AND STIMULATE NEURAL PHYSIOLOGY

(71) Applicant: ADAPTIVE NEURO, LLC, Claymont, DE (US)

(72) Inventors: Hannes HOLSTE, Los Angeles, CA (US); Benjamin BERMAN, San Francisco, CA (US)

(21) Appl. No.: 17/751,378

(22) Filed: May 23, 2022

Related U.S. Application Data
(60) Provisional application No. 63/191,780, filed on May 21, 2021.

(51) Int. Cl. G06N 20/00; G06F 11/34; G06K 9/62

(52) U.S. Cl. CPC G06N 20/00; G06F 11/3457; G06K 9/6232

(57) ABSTRACT

In one aspect, a method includes loading, at a local computing device and at a remote computing device, a machine learning model comprising layers; measuring, at the local computing device, parameters for each of the; determining, based on the parameters, a first set of the one or more layers of the machine learning model to execute by the local computing device and a second set of the layers of the machine learning model to execute at the remote computing device; receiving, from a sensor, a first output, and subsequently inputting the first output into the first set of the layers of the machine learning model executed by the local computing device; and receiving, from the first set of the layers of the machine learning model, a second output, and subsequently transmitting the second output to the remote computing device.

### CROSS-REFERENCE TO RELATED APPLICATION

This application claims priority to U.S. Provisional Patent Application Ser. No. 63/191,780, filed on May 21, 2021, the entire disclosure of which is incorporated herein by reference.

### TECHNICAL FIELD

This disclosure relates generally to brain-computer interfaces. More specifically, this disclosure relates to a system and method for using machine learning models with sensors to interpret and stimulate neural physiology.

### BACKGROUND

Humans and/or animals may partially or completely lose certain sensory and/or motor functions. Brain-computer interfaces (BCIs) provide a modality to restore those lost sensory and motor functions to animals and/or humans. BCIs may also be used to provide treatment of neurological and neuropsychiatric disorders. Further, BCIs may provide enhancement of natural brain function.

### SUMMARY

In one aspect, a method includes loading, at a local computing device and at a remote computing device, a machine learning model comprising layers; measuring, at the local computing device, parameters for each of the; determining, based on the parameters, a first set of the one or more layers of the machine learning model to execute by the local computing device and a second set of the layers of the machine learning model to execute at the remote computing device; receiving, from a sensor, a first output, and subsequently inputting the first output into the first set of the layers of the machine learning model executed by the local computing device; and receiving, from the first set of the layers of the machine learning model, a second output, and subsequently transmitting the second output to the remote computing device.

In one aspect, a computer-implemented method for executing a software platform is disclosed. The method comprises receiving, at a mobile computing device associated with a user, low fidelity data from a microelectrode array of a brain-computer interface, wherein the data is received via a local network connection; transmitting, to a remote computing device, the data using a wide area network; training, at the remote computing device, a machine learning model to produce high fidelity data based on the low fidelity data, wherein the high fidelity data is associated with a function to perform via the mobile computing device; transmitting, to the mobile computing device, the high fidelity data to be used by the mobile computing device to perform the function; and executing a closed-loop feedback system by receiving feedback pertaining to execution of the function at the mobile computing device and transmitting the feedback to the remote computing device to further train the machine learning model.

In another aspect, a system may include a memory device storing instructions and a processing device communicatively coupled to the memory device. The processing device may execute the instructions to perform one or more operations of any method disclosed herein.

In another aspect, a tangible, non-transitory computer-readable medium may store instructions and a processing device may execute the instructions to perform one or more operations of any method disclosed herein.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, independent of whether those elements are in physical contact with one another. The terms “transmit,” “receive,” and “communicate,” as well as derivatives thereof, encompass both direct and indirect communication. The terms “transmit,” “receive,” and “communicate,” as well as derivatives thereof, encompass both communication with remote systems and communication within a system, including reading and writing to different portions of a memory device. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “translate” may refer to any operation performed wherein data is input in one format, representation, language (computer, purpose-specific, such as drug design or integrated circuit design), structure, appearance or other written, oral or representable instantiation and data is output in a different format, representation, language (computer, purpose-specific, such as drug design or integrated circuit design), structure, appearance or other written, oral or representable instantiation, wherein the data output has a similar or identical meaning, semantically or otherwise, to the data input. Translation as a process includes but is not limited to substitution (including macro substitution), encryption, hashing, encoding, decoding or other mathematical or other operations performed on the input data. The same means of translation performed on the same input data will consistently yield the same output data, while a different means of translation performed on the same input data may yield different output data which nevertheless preserves all or part of the meaning or function of the input data, for a given purpose. Notwithstanding the foregoing, in a mathematically degenerate case, a translation can output data identical to the input data. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable storage medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable storage medium” includes any type of medium capable of being accessed by a computer, such as read only memory (ROM), random access memory (RAM), a hard disk drive, a compact disc (CD), a digital video disc (DVD), solid state drive (SSD), or any other type of memory. A “non-transitory” computer readable storage medium excludes wired, wireless, optical, or other communication links that transport transitory electrical or other signals. A non-transitory computer readable storage medium includes media where data can be permanently stored and media where data can be stored and later overwritten, such as a rewritable optical disc or an erasable memory device.

The term “co-processor” may be used interchangeably with “local computing device,” and/or “mobile computing device” herein.

The term “extrinsic co-processor” may be used interchangeably with “remote computing device,” and/or “remote server” herein.

The term “machine learning model” may be used interchangeably with “application” herein.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level component diagram of an illustrative system architecture according to certain embodiments of this disclosure;

FIG. 2 illustrates a component diagram of a local computing device and a remote computing device according to certain embodiments of this disclosure;

FIG. 3 illustrates example operations of a method for determining what portions of a machine learning model to operate on a local computing device and a remote computing device according to certain embodiments of this disclosure;

FIG. 4 illustrates example operations of a method for executing a software platform according to certain embodiments of this disclosure; and

FIG. 5 illustrates an example computer system according to certain embodiments of this disclosure.

### DETAILED DESCRIPTION

Functioning, implanted devices, such as brain-computer interfaces (BCIs) in humans and/or animals conventionally use up to 256 electrodes to record signal and/or stimulate physiological responses. However, there is a need to enable the use of many more electrodes, such as, for example, more than 256 electrodes (e.g., between 1,000 and 65,000 channels). The need for increased channels of data may stem from a desire to obtain higher fidelity feedback that can be used for various applications, such as voice synthesis, kinematic stimulation, and the like. The increase in the number of electrodes provides several technical challenges. One technical challenge is that the increase in the number of electrodes causes a larger volume of output data. Accordingly, such increase may demand not only more advanced machine and deep learning algorithms, but also more powerful, and therefore more expensive, and larger hardware, which far exceeds the capabilities of conventional software and hardware used on on-board processing units to which BCIs are currently tethered. In some instances, BCI users are tethered to a larger computing rig by cable, but that presents practical mobility challenges. There is a need in the field to enable fully wireless and mobile solutions. Further, the bandwidth to communicate with an external server may vary and transmitting a large dataset from a local computing device to a remote computing device (e.g., that has the processing, storage, and power capability to process the large dataset) may provide another technical challenge. The remote computing device may be a high-performance computer processing unit, such as those stored in a datacenter and that is not typically portable.

In some embodiments, software on a co-processor (local computing device) for a BCI may host devices that perform a first and compressive layer of a convolutional (or recurrent) neural network (e.g., deep neural networks) in a neural sensing application (or a last and de-compressive layer of a reversed network in a neural stimulation application). The co-processor sends the significantly compressed output of the first layer to a remote computing device, which continues evaluating the convolutional neural network based on the compressed output. The remote computing device sends back the resulting data to the co-processor. In some embodiments, the resulting data from the remote computing device may include outputs from neural network intermediate layers.

Remote computing devices have computational, energy and storage capabilities that exceed what could be personally portable on a mobile computing device, in clothing, attached to a user's body, or in a vehicle. For example, a datacenter has access to huge corpus of data that is infeasible to transport, like all the recorded microarray data ever, or all of social media videos ever recorded, or trillions of phone calls. The datacenter including one or more remote computing devices has powerful dedicated hardware for online (real-time additive) training of machine learning models, such as neural networks (e.g., user personalization applications). The datacenter including the one or more remote computing devices has access to megawatts of power needed to run all the hardware to store, process, and transmit this data. However, the bandwidth requirements of a microelectrode array (sensing or stimulating) may exceed typical Internet bandwidths.

In some embodiments, the local computing device may use a portion of a machine learning model to compress a sensing signal (or to decompress a stimulating signal) in an application-optimized manner. Specifically, neural networks are capable of higher-order sensing and stimulating applications (e.g., speech synthesis and kinematic feedback) in the context of BCIs for animals and humans. The local computing device may exploit a property unique to deep neural networks: a compressive “first layer” in a sensing applications or de-compressive “last layer” in stimulating applications. The local computing device may obtain the intermediate data output by these early (or final) layers, which may be significantly smaller in size than the sensing signal (or stimulating signal), and may send the intermediate data over a low-bandwidth channel (e.g., the Internet connection). The remote computing device may obtain the intermediate data and process it to improve the fidelity of the information stream to generate a stimulating signal. The remote computing device may compress the stimulating signal to a wireless real-time compressed information stream, which may be significantly smaller in size than the stimulating signal. The machine learning model executed by the remote computing device may transmit the stimulating signal over the low-bandwidth channel (e.g., the Internet connection) to the local computing device, and send the intermediate data over the low-bandwidth channel. The compression techniques implemented may achieve the bandwidth reduction necessary to communicate large amounts of data streaming from a microelectrode array to a remote server.

In some embodiments, a preliminary action may be performed on the intermediate data from the first layers of a deep neural network to simulate a lower-latency response than would be possible by a remotely executed deep neural network alone. Likewise, in some embodiments, a preliminary action may be performed on the intermediate data from the last layers of a deep neural network to simulate a lower-latency response than would be possible by a remotely executed deep neural network alone. For example, the lower fidelity (“rough”) kinematic feedback stimulation can be performed by the local computing device with just the first layer of a deep neural network (i.e. the device may simulate a simple feed-forward network) for the purposes of reducing latency. The local computing device may wait until the results from the complete network arrive from the remote computing device to deliver high fidelity (“fine”) feedback stimulating blended in time with the lower-latency local results. In some embodiments, a low-fidelity voice may be synthesized for feedback to provide to the user in personal headphones in real-time using the feed-forward part of the neural network, while a high fidelity voice with a small delay due to Internet round trip transmission may be emitted from a user's wheelchair speakers, for example.

In some scenarios, network bandwidth available to communicate with an remote server varies. For example, an end user's local computing device might transition from home Wi-Fi (high bandwidth) to cellular 5G (high bandwidth) to cellular 3G (low bandwidth) to no signal (no bandwidth) throughout the day. The system may be capable of reacting adaptively by trading off local computation of the deep neural network for latency (i.e. because the local device is less performant) based on an expected value of remote execution. The local computing device may dynamically determine how many layers/parts of the machine learning model should be executed locally versus remotely based on various parameters (e.g., available bandwidth, measured latency, and domain-specific costs/benefits (like safety, minimum versus nice-to-have-quality-of-voice audio, etc.)).

In some embodiments, the local computing device may be an accelerator (e.g., Universal Serial Bus accelerator, such as Google Edge TPU Coprocessor®. The local computing device may be attached to a system on a chip (SoC) memory system configured with high bandwidth memory, Input/Output (IO) to the microelectrode array and an 802.11ay (ultra-high bandwidth line of sight) or 802.11ax (next gen Wi-Fi) wireless adapter, for example.

In some embodiments, a neurophysiological machine learning model may be generated trained to perform one or more neurophysiological operations. The machine learning model may use one or more deep neural networks. Some machine learning models might access large amounts of data, and perform online training (as opposed to inference), which may be computational infeasible on portable devices or at interactive latencies.

A software developer or the artificial intelligence may generate a “hardware model” of a quality of the machine learning model's results as a function of latency and depth of the machine learning model executed. In other words, the hardware morel's output describes tradeoffs. The hardware model may be implemented in computer instructions stored in a memory device and executed by the local computing device.

A software developer or the artificial intelligence may generate a “profiler module” to measure the performance of each layer of the machine learning model on sample or real data. The one or more measurements may calculate an execution time and output data size for each layer, and the associated quality of the result thus far according to the “hardware model.” The profiler module may be implemented in computer instructions stored in a memory device and executed by the local computing device. The profiler module may output profiling data.

Using the profiling data, a “scheduler module” may determine, based on various parameters (e.g., the available bandwidth, battery of the microprocessor array and local computing device, execution time, etc.) fed as a function to the “hardware model,” how many layers of the machine learning model to execute on the local computing device versus on a remote computing device. The scheduler module may be implemented in computer instructions stored in a memory device and executed by the local computing device.

A “blender module” may blend time-delayed response from the remote server and the locally executed part of the machine learning model into a final result. For high latency applications, like voice synthesis, the blender might output a low quality voice to the personal headphones of the user, while it outputs a time-delayed high quality voice to the external speaker the conversants will hear. For interactive applications, like real-time motion, it might interpolate past remote response results with current local results. The blender module may be implemented in computer instructions stored in a memory device and executed by the local computing device.

The machine learning model on the local computing device may use this blended result of signals to perform its function. The function may include sending the blended result of signals to the BCI to cause a stimulation, a feeling, and/or a voice synthesis.

The artificial intelligence (AI) engine may use one or more machine learning models (e.g., deep learning neural networks) to perform various operations disclosed herein. The various models and modules described herein may be executed in an automated fashion in real-time or near real-time to optimize how the machine learning model is executed on the local computing device and the remote computing device.

Any suitable electrodes associated with BCIs may be used to perform the disclosed techniques. The electrodes associated with the BCIs may measure brain signals and/or waves (electroencephalography (EEG) brainwaves). The BCIs may be used to restore sight, hearing, movement (e.g. kinematics), memory, speech, ability to communicate, and/or cognitive function, among other things. Invasive electrodes that are implanted under a scalp may be used to communicate brain signals. In some embodiments, invasive electrodes may be used to repair damaged sight and provide new functionality for people with paralysis. Invasive BCIs may be implanted directly into grey matter of the brain during neurosurgery. In some embodiments, electrodes may be implanted onto a visual cortex to produce phosphenes that produce the sensation of seeing light. Electrodes may be implanted onto a brain to produce signals to stimulate movement. Other types of BCIs may be partially implanted such that they are inside the skull but rest outside the brain rather than within the grey matter. Further, the disclosed techniques may be used with non-invasive BCIs, such as non-invasive neuroimaging technologies.

The disclosed techniques may provide a technical solution by providing a system and method to use machine learning models together with microelectrode arrays to interpret and stimulate neural physiology based on certain parameters to optimize the consumption of resources between a local computing device and a remote computing device. In some embodiments, the processing of the machine learning models may occur first on a local computing device in a local connectivity network with the microelectrode array, while subsequent processing occurs on a remote computing device in a remote connectivity network. In some embodiments, the processing of the machine learning models may occur last on a local computing device in a local connectivity network with the microelectrode array, while earlier processing occurs on a remote computing device in a remote connectivity network.

Further, the technical solution provides higher fidelity feedback by blending the results of both computing devices by leveraging a combination of processing at the local computing device and processing at the more powerful remote computing device. Further, the amount of processing performed at the local computing device and the remote computing device is continuously optimized in real-time as a user moves around and network bandwidth changes. Based on the available bandwidth, the compression techniques used by the local and remote computing device enable enhanced and more efficient transmission of data over the network. Further, the user's experience using the disclosed system and method may be enhanced because the higher fidelity feedback may enable the local device to perform a higher quality function as opposed to conventional systems, thereby providing a technical improvement.

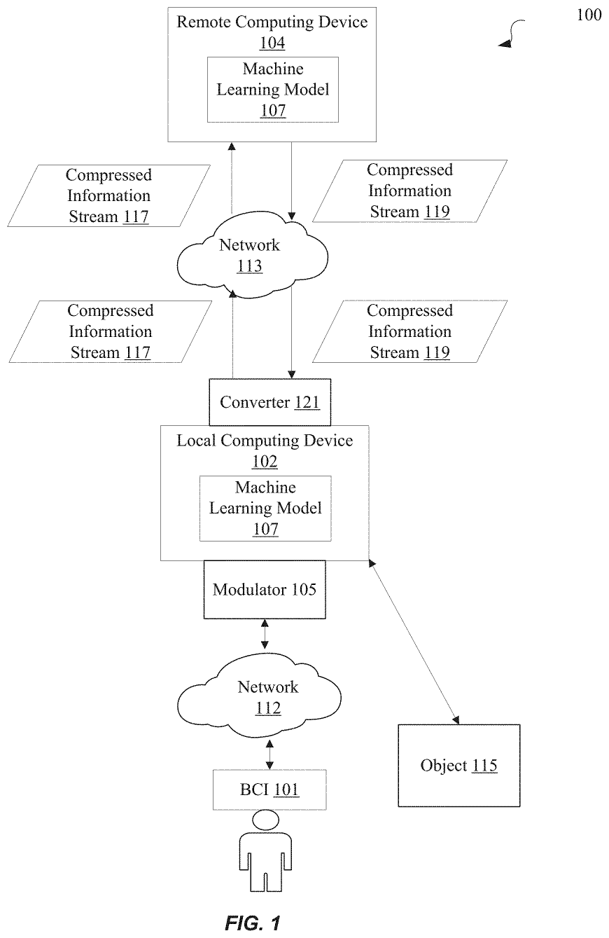

FIG. 1 illustrates a high-level component diagram of an illustrative system architecture 100 according to certain embodiments of this disclosure. In some embodiments, the system architecture 100 represents a sensing system. In some embodiments, the system architecture 100 may include a local computing device 102 communicatively coupled to a brain-computer interface (BCI) 101 including a microelectrode array. In some embodiments, the local computing device 102 may be coupled to the BCI 101 via a network 112 wirelessly (e.g., Bluetooth, Wi-Fi, ZigBee) or via a wire (e.g., cables). The local computing device 102 may be an accelerator (e.g., Universal Serial Bus accelerator, such as Google Edge TPU Coprocessor®). The local computing device may be attached to a system on a chip (SoC) memory system configured with high bandwidth memory, Input/Output (TO) to the microelectrode array and an 802.11ay (ultra-high bandwidth line of sight) or 802.11ax (next gen Wi-Fi) wireless adapter, for example. In some embodiments, the wireless adapter may enable wireless communication via network 113 (e.g., wide area network, such as Wi-Fi).

The microelectrode array associated with the BCI 101 may include a high density (e.g., 1,000 to 65,000 electrodes) microelectrode array (e.g., the Utah Array by Blackrock Microsystems®) The microelectrode array may sense and stimulate the brain. The microelectrode array may transmit signals to the local computing device 102. A modulator 105 may be used to convert analog signals from the microelectrode array (e.g., in a sensing mode) to a media chip that puts data on the wire from the microelectrode array.

As described herein, both the local computing device 102 and the remote computing device 104 may include a machine learning model 107. The machine learning model 107 may include a deep neural network with numerous layers (e.g., tens, hundreds, thousands). The machine learning model 107 may be implemented in computer instructions stored on a memory device and executed by a processing device at each of the local computing device and the remote computing device 104. Due to the sheer amount of signals streaming from the high density microelectrode array, the local computing device 102 may perform operations to determine which layers of the machine learning model 107 executing on the local computing device 102 should process the signals and which layers of the machine learning model 107 executing on the remote computing device 104. The remote computing device 104 may be a high-performance computer processing unit capable with a much larger capacity for processing, storage, and battery life than the local computing device 102. Thus, the local computing device 102 may use a hardware model to run simulations to determine, based on execution and power limitations, how many layers of the machine learning model 107 to use on the local computing device. The execution and power limitations may be provided in a configuration file associated with the local computing device 102 and the configuration file may include various other specifications (e.g., memory limitations, etc.).

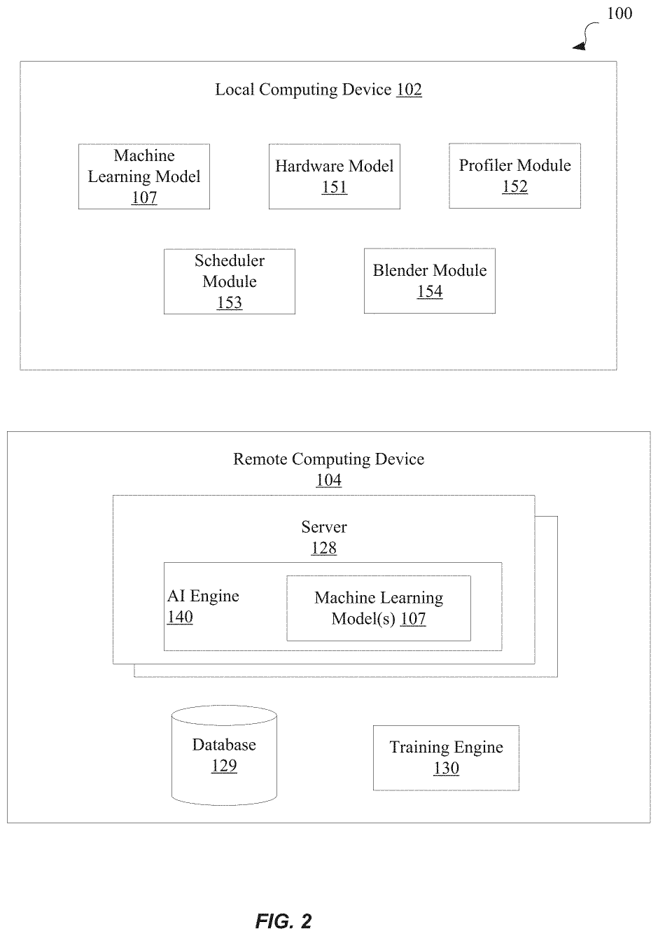

In some embodiments, the remote computing device 104 may include one or more servers 128 that form a distributed computing system, which may include a cloud computing system. The remote computing device 104 may be a rackmount server and/or a high-performance computer processing unit (e.g., a datacenter). The remote computing device 104 may include one or more processing devices, memory devices, data storage, or network interface cards. As depicted in FIG. 2, the remote computing device 104 may execute an artificial intelligence (AI) engine 140 that trains one or more machine learning models 107 to perform at least one of the embodiments disclosed herein. The remote computing system 104 may also include a database 129 that stores data, knowledge, and data structures used to perform various embodiments. For example, the database 150 may store user profiles about brain signals and responses to certain stimulating signals, and additional training data used to train the machine learning models 107. Although depicted separately from the server 128, in some embodiments, the database 129 may be hosted on one or more of the servers 128.

In some embodiments the remote computing device 104 may include a training engine 130 capable of generating one or more machine learning models 107. Although depicted separately from the AI engine 140, the training engine 130 may, in some embodiments, be included in the AI engine 140 executing on the server 128. In some embodiments, the AI engine 140 may use the training engine 130 to generate the machine learning models 107 trained to perform online training using large amounts of brain signal data, response data to the brain signal data, feedback pertaining to functions performed, user brain profile data, and the like. In some embodiments, the machine learning model 107 may be trained to perform inferencing operations. The machine learning models 107 may be trained to compress a sensing signal and/or decompress stimulating signal. The one or more machine learning models 107 may be generated by the training engine 130 and may be implemented in computer instructions executable by one or more processing devices of the training engine 130 or the servers 128. To generate the one or more machine learning models 107, the training engine 130 may train the one or more machine learning models 107.

The training engine 130 may be a rackmount server, a router, a personal computer, a portable digital assistant, a smartphone, a laptop computer, a tablet computer, a netbook, a desktop computer, an Internet of Things (IoT) device, any other desired computing device, or any combination of the above. The training engine 130 may be cloud-based, be a real-time software platform, include privacy software or protocols, or include security software or protocols.

The training engine 130 may use a base data set of real data or sample data associated with sensing signals and/or stimulating signals to train the machine learning models 107 to compress and decompress the sensing signals and the stimulating signals, respectively. Further, based on feedback from users pertaining to a quality of execution of a function performed as a result of a signal, the training engine 130 may perform a closed-loop feedback system to iteratively train the machine learning models 107. In addition, the training engine 130 may train the machine learning models 107 to perform dimensionality reduction techniques on a global data set to learn what are individual variations of users, and to provide certain stimulating signals based on similarities of reactions between users.

The one or more machine learning models 107 may refer to model artifacts created by the training engine 130 using training data that includes training inputs and corresponding target outputs. The training engine 130 may find patterns in the training data wherein such patterns map the training input to the target output and generate the machine learning models 107 that capture these patterns. Further, in some embodiments, the artificial intelligence engine 140, the database 129, or the training engine 130 may reside on the local computing device 102.

The one or more machine learning models 107 may comprise, e.g., a single level of linear or non-linear operations (e.g., a support vector machine (SVM)) or the machine learning models 107 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each artificial neuron may transmit its output signal to the input of the remaining neurons, as well as to itself). For example, the machine learning model may include numerous layers or hidden layers that perform calculations (e.g., dot products) using various neurons.

The first layer (or first few layers) of the machine learning model 107 may be trained to compress a sensing signal to a size much smaller than the original sensing signal and the local computing device 102 transmits the compressed information stream 117 to the remote computing device 104 via the network 113. A layer (or last few layers) of the machine learning model 107 executing on the remote computing device 104 may be trained to process the intermediate data received from the local computing device 102 to generate higher fidelity data (e.g., by removing noise in the information stream). The machine learning model 107 executing on the remote computing device 104 may compress the higher fidelity data and transmit a compressed information stream 119 (a stimulating signal) back to the local computing device 102 via the network 113. As shown in FIG. 1, an analog to digital converter 121 may be used to convert the signals for the local computing device 102 and/or the remote computing device 104.

The local computing device 102 may receive the compression information stream 119 and execute a last layer of the machine learning model 107 to decompress the stimulating signal. In some embodiments, the higher fidelity information received from the remote computing device 104 may be time-blended with the lower fidelity information generated by the layers executed on the local computing device 102. The blended results may be used to perform a function by the local computing device 102. For example, a function may be to control an object 115, such as a wheelchair to emit a synthesized voice, to control a handle on the wheelchair to cause the wheelchair to move, to provide a stimulation to a portion of the user's brain, to cause a portion of the user's body to move, or the like.

In some embodiments, the machine learning model 107 may be installed or loaded as external procedures on both the local computing device 102 and the remote computing device 104.

FIG. 2 illustrates additional components of the local computing device 102 and the remote computing device 104. The components of the remote computing device 104 are discussed above, but it should be noted that more or less components may be included in the remote computing device 104. The local computing device 102 includes the machine learning model 107, a hardware model 151, a profiler module 152, a scheduler module 154, and a blender module 154. In some embodiments, each of the hardware model 151, profiler module 152, scheduler module 154, and blender module 154 may be machine learning models trained, based on training data, to perform their respective functions.

The hardware model 151 may be generated using configuration information of limitations (e.g., execution, power, memory, etc.) of the local computing device 102. In some embodiments, the hardware model 151 may be generated based on profiling the local computing device 102. The hardware model 151 may be executed of a quality of the machine learning model's results as a function of latency and depth of the machine learning model executed. In other words, the hardware model's 151 output describes tradeoffs. The hardware model may be implemented in computer instructions stored in a memory device and executed by the local computing device.

The profiler module 152 may measure the performance of each layer of the machine learning model on sample or real data. The one or more measurements may calculate an execution time and output data size for each layer, and the associated quality of the result according to the hardware model 151. The profiler module 152 may be implemented in computer instructions stored in a memory device and executed by the local computing device. The profiler module 152 may output profiling data.

Using the profiling data, the scheduler module 153 may determine, based on various parameters (e.g., the available bandwidth, battery of the microprocessor array and local computing device, execution time, etc.) fed as a function to the hardware model 151, how many layers of the machine learning model to execute on the local computing device versus on a remote computing device. The scheduler module 153 may be implemented in computer instructions stored in a memory device and executed by the local computing device.

The blender module 154 may blend time-delayed response from the remote server and the locally executed part of the machine learning model into a final result. For high latency applications, like voice synthesis, the blender module 154 might output a low quality voice to the personal headphones of the user, while it outputs a time-delayed high quality voice to the external speaker the conversants will hear. For interactive applications, like real-time motion, it might interpolate past remote response results with current local results. The blender module 154 may be implemented in computer instructions stored in a memory device and executed by the local computing device.

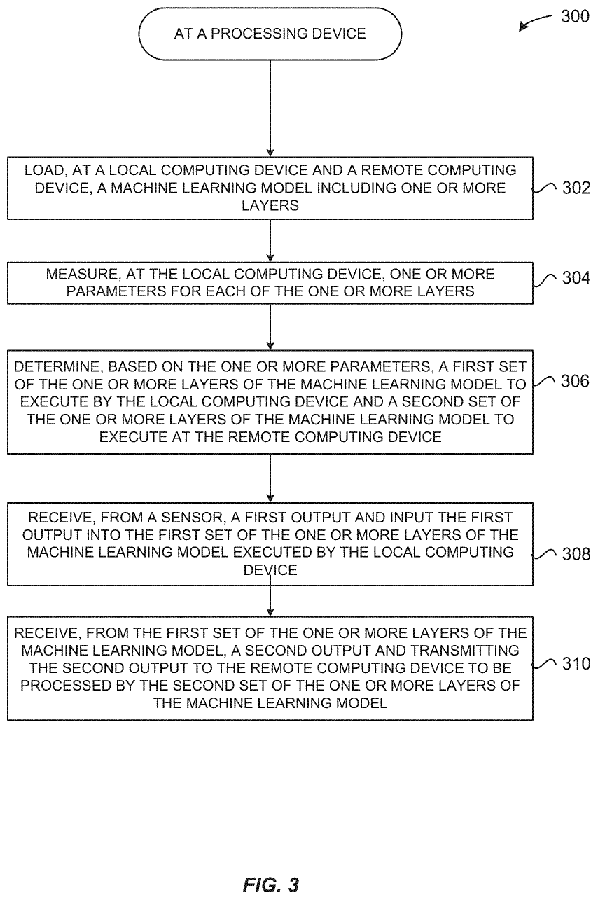

FIG. 3 illustrates example operations of a method 300 for determining what portions of a machine learning model to operate on a local computing device and a remote computing device. Method 300 includes operations performed by processors of a computing device (e.g., any component of FIG. 1, such as the local computing device 102, the remote computing device 104, the BCI 101, the object 115, etc.). In some embodiments, one or more operations of the method 300 are implemented in computer instructions that are stored on a memory device and executed by a processing device. The method 300 may be performed in the same or a similar manner as described above in regard to method 300. The operations of the method 300 may be performed in some combination with any of the operations of any of the methods described herein.

At 302, a machine learning model 107 may be loaded at a local computing device 102 and at a remote computing device 104. In some embodiments, the machine learning model is associated with a neurophysiological function. In some embodiments, the local computing device 102 includes a mobile or portable computing device and the remote computing device 104 includes a high-performance computing unit.

At 304, one or more parameters may be measured at the local computing device 102. The one or more parameters may be measured for each of the one or more layers of the machine learning model 107.

At 306, based on the one or more parameters, a first set of the one or more layers of the machine learning model 107 may be determined to execute by the local computing device 102, and a second set of the one or more layers of the machine learning model 107 may be determined to execute at the remote computing device 104. The machine learning model 107 may be loaded or installed as one or more external procedures at the local computing device 102 and at the remote computing device 104. Determining the first and second sets of layers may be performed using sample signal data and real signal data. The one or more parameters may include an execution time, an output data size, a quality of a result associated with latency, a quality of a result associated with a depth of the machine learning model executed, or some combination thereof.

At 308, a first output may be received from a sensor (e.g., a microelectrode array connected to a brain-computer interface). The first output may include signal data associated with a range of 1,000 to 65,000 channels of electrodes. The first output may be received via a local network connection (e.g., wired, or local area network, etc.). The first output may be input into the first set of the one or more layers of the machine learning model 107 executed by the local computing device 102. In some embodiments, the first set of layers 107 may be trained to compress the signal using deep autoencoding via a recurrent neural network configured to output smaller sized compressed data.

At 310, a second output may be received from the first set of the one or more layers of the machine learning model 107. The second output may be transmitted via a wireless wide area network to the remote computing device 104 to be processed by the second set of the one or more layers of the machine learning model 107. The second set of the one or more layers are different than the first set of the one or more layers, and the second set of the one or more layers is not executed by the local computing device 102.

In some embodiments, a third output may be received via a wide area network from the second set of the one or more layers of the machine learning model 107 executed at the remote computing device 104. A fourth output may be generated using the third output to resume execution of the machine learning model 107 on the local computing device at a layer subsequent to the first and second set of layers. In other words, the layer performed next by the local computing device 102 is a layer immediately subsequent to the last layer performed in the second set of layers by the remote computing device 104. The layer performed by the local computing device 102 may decompress the compressed information stream sent by the remote computing device 104. In some embodiments, the decompressed information stream received from the remote computing device 104 may be blended or combined with the local results generated by the first set of layers at the local computing device 102. The blended results may provide enhanced quality of information due in real-time or near real-time due to the remote computing device 104 executing the bulk of the difficult processing. Further the techniques may save battery power of the local computing device 102 by only performing layers of the machine learning model 107 within certain limitations. In addition, the compression techniques described herein reduce the bandwidth consumption and enhance response time.

In some embodiments, a function may be executed by the local computing device based on the fourth output. The function include controlling an object (e.g., wheelchair, speaker, headset, etc.), causing a stimulation to a portion of the user's brain via the microelectrode array, and the like.

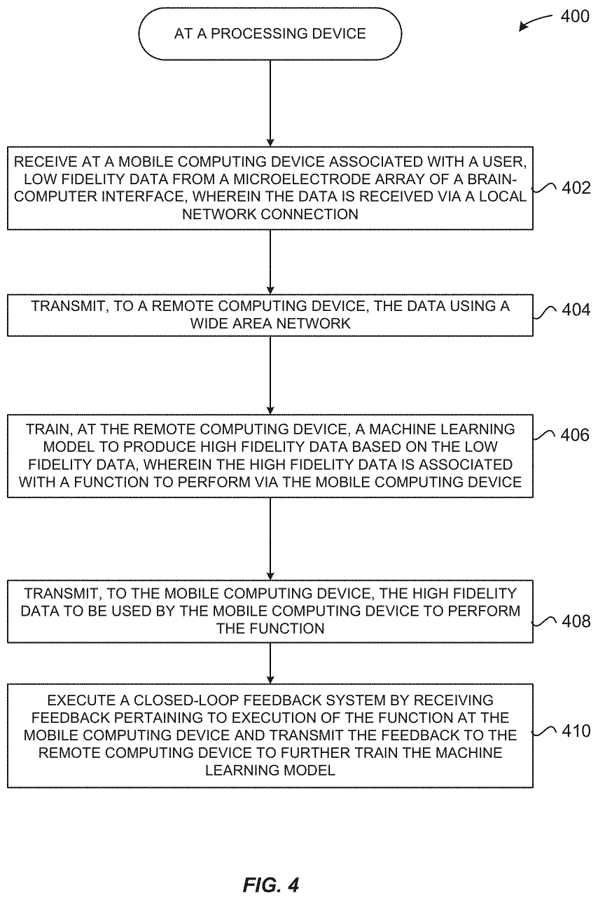

FIG. 4 illustrates example operations of a method 400 for determining what portions of a machine learning model to operate on a local computing device and a remote computing device. Method 400 includes operations performed by processors of a computing device (e.g., any component of FIG. 1, such as the local computing device 102, the remote computing device 104, the BCI 101, the object 115, etc.). In some embodiments, one or more operations of the method 400 are implemented in computer instructions that are stored on a memory device and executed by a processing device. The method 400 may be performed in the same or a similar manner as described above in regard to method 400. The operations of the method 400 may be performed in some combination with any of the operations of any of the methods described herein.

The method 400 relates to executing a software platform including the models and modules described herein, the networks described herein, and/or the devices described herein.

At 402, low fidelity data may be received at a mobile computing device associated with a user. The low fidelity data may be received from a microelectrode array of a brain-computer interface. The data may be received via a local network connection (e.g., wired or local area network).

At 404, the data may be transmitted to a remote computing device using a wide area network (e.g., Wi-Fi).

At 406, a machine learning model 107 may be trained at the remote computing device 104 to produce high fidelity data based on the low fidelity data. The high fidelity data is associated with a function to perform via the mobile computing device. The machine learning model 107 is trained to at least filter out noise from the low fidelity data to generate the high fidelity data.

At 408, the high fidelity data may be transmitted to the mobile computing device to be used to perform the function.

At 410, a closed-loop feedback system may be executed by receiving feedback pertaining to execution of the function at the mobile computing device and transmitting the feedback to the remote computing device 104 to further train the machine learning model 107.

In some embodiments, a set of mobile computing devices are associated with a set of users and each of the set of users is using a brain-computer interface. The closed-loop feedback system may be executed based on the set of feedback received from the set of mobile computing devices. In some embodiments, one or more dimensionality reduction techniques may be executed to identify user variations between the plurality of feedback and users. The machine learning model 107 may be further trained based on the user variations to generate user profiles, for example.

In some embodiments, an interface (e.g., website, stand-alone application installed on a tablet, smartphone, desktop computer, laptop computer, etc.) may be provide to access the software platform via the wide area network. In some embodiments, a scenario may be replayed that represents the high fidelity data and execution of the function at the mobile computing device. Based on the replayed scenario, another machine learning model or the machine learning model may simulate execution of a second scenario that represents second high fidelity data and execution of a second function at the mobile computing device.

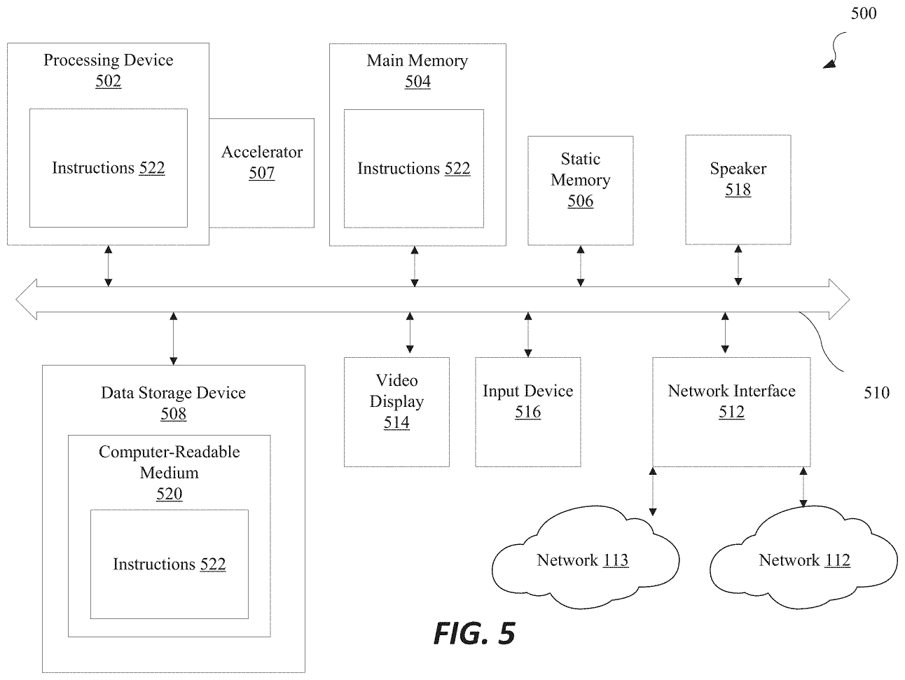

FIG. 5 illustrates example computer system 500 which can perform any one or more of the methods described herein, in accordance with one or more aspects of the present disclosure. In one example, computer system 500 may correspond to the computing device 102, remote computing device 104, one or more servers 128 of the remote computing device 104, the training engine 130, the BCI 101, or any suitable component of FIGS. 1 and 2. The computer system 500 may be capable of executing the one or more machine learning models 107, the artificial intelligence engine 140, the hardware model 151, and the modules 152, 153, and 154 of FIGS. 1 and 2. The computer system may be connected (e.g., networked) to other computer systems in a LAN, an intranet, an extranet, or the Internet. The computer system may operate in the capacity of a server in a client-server network environment. The computer system may be a high-performance computer unit, personal computer (PC), a tablet computer, a wearable (e.g., wristband), a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 500 includes a processing device 502, a volatile memory 504 (e.g., random access memory (RAM)) and a non-volatile memory 506 (e.g., read-only memory (ROM), flash memory, solid state drives (SSDs), and a data storage device 1108, which communicate with each other via a bus 510.

Processing device 502 represents one or more general-purpose processing devices such as an accelerator, microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a system on a chip, a field programmable gate array (FPGA), a digital signal processor (DSP), network processor, or the like. The processing device 502 may include more than one processing device, and each of the processing devices may be the same or different types. The processing device 502 may include or be communicatively coupled to one or more accelerators 507 configured to offload various data-processing tasks from the processing device 502. The processing device 502 is configured to execute instructions for performing any of the operations and steps discussed herein.

The computer system 500 may further include a network interface device 512. The network interface device 512 may be configured to communicate data via any suitable communication protocol. In some embodiments, the network interface devices 512 may enable wireless (e.g., WiFi, Bluetooth, ZigBee, etc.) or wired (e.g., Ethernet, etc.) communications. The computer system 500 also may include a video display 514 (e.g., a liquid crystal display (LCD), a light-emitting diode (LED), an organic light-emitting diode (OLED), a quantum LED, a cathode ray tube (CRT), a shadow mask CRT, an aperture grille CRT, or a monochrome CRT), one or more input devices 516 (e.g., a keyboard or a mouse), and one or more speakers 518 (e.g., a speaker). In one illustrative example, the video display 514 and the input device(s) 516 may be combined into a single component or device (e.g., an LCD touch screen).

The data storage device 516 may include a computer-readable medium 520 on which the instructions 522 embodying any one or more of the methods, operations, or functions described herein is stored. The instructions 522 may also reside, completely or at least partially, within the main memory 504 or within the processing device 502 during execution thereof by the computer system 500. As such, the main memory 504 and the processing device 502 also constitute computer-readable media. The instructions 522 may further be transmitted or received over a network 112 or 113 via the network interface 512.

While the computer-readable storage medium 520 is shown in the illustrative examples to be a single medium, the term “computer-readable storage medium” should be taken to include a single medium or multiple media (e.g., a centralized or distributed database, or associated caches and servers) that store the one or more sets of instructions. The term “computer-readable storage medium” shall also be taken to include any medium capable of storing, encoding, or carrying a set of instructions for execution by the machine, where such set of instructions cause the machine to perform any one or more of the methodologies of the present disclosure. The term “computer-readable storage medium” shall accordingly be taken to include, but not be limited to, solid-state memories, optical media, and magnetic media.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

Consistent with the above disclosure, the examples of systems and method enumerated in the following clauses are specifically contemplated and are intended as a non-limiting set of examples.

Clause 1. A sensing system between a microelectrode array (the “array”) and secondary processing devices (the “co-processors”) wherein the sensing system compromises:

a. a microelectrode array (e.g., the 65k Utah Array)

b. a co-processor connected to the memory and converter

c. a transmission media connecting the microelectrode array to a co-processor

d. a network transmission system (e.g., WiFi) connecting the co-processor to a wide area network (e.g., the Internet)

e. a sensing system method on the co-processor

f. an extrinsic machine 1 earning application

g. an extrinsic co-processor on the wide area network.

Clause 2. The sensing system of any clause herein, wherein the co-processor further comprise:

a. specialized hardware for the efficient execution of neural networks

b. a memory for storing and buffering converted digital data

c. a modulator converting analog signals from the array in a sensing mode to the media (e.g., chip that puts data on the wire from the array)

d. an analog to digital converter (ADC) of the signals from the media for a computer co-processor.

Clause 3. The sensing system method of any clause herein, further comprising:

a. an extrinsic machine learning application's deep neural network(s) are loaded as external procedures

b. a configuration is provided or generated via profiling of the co-processor that specifies a limitation on execution time and limitation on power usage of this sensing method

c. sample or real data is used to determine how many layers of deep neural network(s) of the extrinsic machine learning application can be executed by the co-processor within the execution and power limitations specified by the configuration

d. the outputs of the microelectrode array received by the co-processor are inputted into the determined number of layers of the deep neural network, executed as external procedures stored in an earlier step.

e. the output of the external procedure (“intermediate neural network data”) is transmitted to an extrinsic co-processor on the wide area network for further processing

f. the remaining, unexecuted layers are executed on this extrinsic co-processor and the results are transmitted back to the method via the same transmission system.

g. the extrinsic machine learning application's execution is resumed on the co-processor at the procedure last executed by the extrinsic co-processor.

Clause 4. A computer-implemented method comprising:

loading, at a local computing device and at a remote computing device, a machine learning model comprising one or more layers;

measuring, at the local computing device, one or more parameters for each of the one or more layers;

determining, based on the one or more parameters, a first set of the one or more layers of the machine learning model to execute by the local computing device and a second set of the one or more layers of the machine learning model to execute at the remote computing device;

receiving, from a sensor, a first output and inputting the first output into the first set of the one or more layers of the machine learning model executed by the local computing device; and

receiving, from the first set of the one or more layers of the machine learning model, a second output and transmitting the second output to the remote computing device to be processed by the second set of the one or more layers of the machine learning model.

Clause 5. The computer-implemented method of any clause herein, wherein the machine learning model is associated with a neurophysiological function.

Clause 6. The computer-implemented method of any clause herein, further comprising:

receiving, from the second set of the one or more layers of the machine learning model executing at the remote computing device, a third output via a wide area network; and

generating, using the third output to resume execution of the machine learning model on the local computing device at a layer subsequent to the first and second set of layers, a fourth output.

Clause 7. The computer-implemented method of any clause herein, further comprising:

executing, via the local computing device, a function based on the fourth output.

Clause 8. The computer-implemented method of any clause herein, wherein the machine learning model is loaded as one or more external procedures at the local computing device and at the remote computing device.

Clause 9. The computer-implemented method of any clause herein, wherein the transmitting the second output is performed via a wide area network.

Clause 10. The computer-implemented method of any clause herein, wherein the first output is received from the sensor via a local network connection.

Clause 11. The computer-implemented method of any clause herein, wherein the output from the first set of the one or more layers of the machine learning model are compressed by a deep neural network.

Clause 12. The computer-implemented method of any clause herein, wherein the determining the first and second sets of the one or more layers of the machine learning model is performed using sample data or real data.

Clause 13. The computer-implemented method of any clause herein, wherein the sensor is a microelectrode array connected to a brain-computer interface.

Clause 14. The computer-implemented method of any clause herein, wherein the one or more parameters comprise an execution time, an output data size, a quality of a result associated with latency, a quality of a result associated with a depth of the machine learning model executed, or some combination thereof.

Clause 15. The computer-implemented method of any clause herein, wherein the local computing device comprises a mobile device and the remote computing device comprises a high-performance computing unit.

Clause 16. The computer-implemented method of any clause herein, wherein the first output comprises data associated with a range of 1,000 to 65,000 channels of electrodes.

Clause 17. A computer-implemented method for executing a software platform, wherein the method comprises:

receiving, at a mobile computing device associated with a user, low fidelity data from a microelectrode array of a brain-computer interface, wherein the data is received via a local network connection;

transmitting, to a remote computing device, the data using a wide area network;

training, at the remote computing device, a machine learning model to produce high fidelity data based on the low fidelity data, wherein the high fidelity data is associated with a function to perform via the mobile computing device;

transmitting, to the mobile computing device, the high fidelity data to be used by the mobile computing device to perform the function; and

executing a closed-loop feedback system by receiving feedback pertaining to execution of the function at the mobile computing device and transmitting the feedback to the remote computing device to further train the machine learning model.

Clause 18. The computer-implemented method of claim 14, wherein a plurality of mobile computing devices are associated with a plurality of users and each of the plurality of users is using a brain-computer interface, and wherein the method further comprises executing the closed-loop feedback system based on a plurality of feedback received from the plurality of mobile computing devices.

Clause 19. The computer-implemented method of any clause herein, further comprising executing one or more dimensionality reduction techniques to identify user variations between the plurality of feedback.

Clause 20. The computer-implemented method of any clause herein, further comprising training the machine learning model using the user variations.

Clause 21. The computer-implemented method of any clause herein, further comprising providing an interface to access the software platform via the wide area network.

Clause 22. The computer-implemented method of any clause herein, further comprising:

replaying a scenario that represents the high fidelity data and execution of the function at the mobile computing device; and

based on the replayed scenario, using a second machine learning model to simulate execution of a second scenario that represents second high fidelity data and execution of a second function at the mobile computing device.

What is claimed is:

1. A computer-implemented method comprising:
loading, at a local computing device and at a remote computing device, a machine learning model comprising one or more layers;
measuring, at the local computing device, one or more parameters for each of the one or more layers;
determining, based on the one or more parameters, a first set of the one or more layers of the machine learning model to execute by the local computing device and a second set of the one or more layers of the machine learning model to execute at the remote computing device;
receiving, from a sensor, a first output, and subsequently inputting the first output into the first set of the one or more layers of the machine learning model executed by the local computing device; and
receiving, from the first set of the one or more layers of the machine learning model, a second output, and subsequently transmitting the second output to the remote computing device to be processed by the second set of the one or more layers of the machine learning model.

2. The computer-implemented method of claim 1, wherein the machine learning model is associated with a neurophysiological function.

3. The computer-implemented method of claim 1, further comprising:
receiving, from the second set of the one or more layers of the machine learning model executing at the remote computing device, a third output via a wide area network; and
generating, using the third output to resume execution of the machine learning model on the local computing device at a layer subsequent to the first and second set of layers, a fourth output.

4. The computer-implemented method of claim 3, further comprising:
executing, via the local computing device, a function based on the fourth output.

5. The computer-implemented method of claim 1, wherein, at the local computing device and at the remote computing device, the machine learning model is loaded as one or more external procedures at the local computing device and at the remote computing device.

6. The computer-implemented method of claim 1, wherein the transmitting the second output is performed via a wide area network.

7. The computer-implemented method of claim 1, wherein the first output is received from the sensor via a local network connection.

8. The computer-implemented method of claim 1, wherein the output from the first set of the one or more layers of the machine learning model is compressed by a deep neural network.

9. The computer-implemented method of claim 1, wherein the determining the first and second sets of the one or more layers of the machine learning model is performed using sample data or real data.

10. The computer-implemented method of claim 1, wherein the sensor is a microelectrode array connected to a brain-computer interface.

11. The computer-implemented method of claim 1, wherein the one or more parameters comprise an execution time, an output data size, a quality of a result associated with latency, a quality of a result associated with a depth of the machine learning model executed, or some combination thereof.

12. The computer-implemented method of claim 1, wherein the local computing device comprises a mobile device and the remote computing device comprises a high-performance computing unit.

13. The computer-implemented method of claim 1, wherein the first output comprises data associated with at least 256 channels of electrodes.

14. A computer-implemented method for executing a software platform, wherein the method comprises:
receiving, at a mobile computing device associated with a user, low fidelity data from a microelectrode array of a brain-computer interface, wherein the data is received via a local network connection;
using a wide area network, transmitting the data to a remote computing device;
training, at the remote computing device, a machine learning model to produce high fidelity data based on the low fidelity data, wherein the high fidelity data is associated with a function to perform via the mobile computing device;
transmitting, to the mobile computing device, the high fidelity data to be used by the mobile computing device to perform the function; and
executing a closed-loop feedback system by receiving feedback pertaining to execution of the function at the mobile computing device, and to further train the machine learning model, transmitting the feedback to the remote computing device.

15. The computer-implemented method of claim 14, wherein a plurality of mobile computing devices is associated with a plurality of users and each of the plurality of users is using a brain-computer interface, and wherein the method further comprises executing the closed-loop feedback system based on a plurality of feedback received from the plurality of mobile computing devices.

16. The computer-implemented method of claim 15, further comprising executing one or more dimensionality reduction techniques to identify user variations between a first element of the plurality of feedback and a second element of the plurality of feedback.

17. The computer-implemented method of claim 16, further comprising training the machine learning model using the user variations.

18. The computer-implemented method of claim 14, further comprising providing an interface to access the software platform via the wide area network.

19. The computer-implemented method of claim 14, further comprising:
replaying a scenario, wherein scenario comprises the high fidelity data and execution of the function at the mobile computing device; and
based on the replayed scenario, using a second machine learning model to simulate execution of a second scenario, wherein the second scenario comprises second high fidelity data and execution of a second function at the mobile computing device.
